(19) United States
(12) Patent Application Publication
(10) Pub. No.: US 2024/0326510 A1
(43) Pub. Date: Oct. 3, 2024

(54) Enhanced Grip Pencil Device

(71) Applicant: Angela Larkin, Rochester, NY (US)

(72) Inventor: Angela Larkin, Rochester, NY (US)

(21) Appl. No.: 18/618,583

(22) Filed: Mar. 27, 2024

Related U.S. Application Data
(60) Provisional application No. 63/493,025, filed on Mar. 30, 2023.

(51) Int. Cl. B43K 23/008; B43K 29/02

(52) U.S. Cl. CPC B43K 23/008; B43K 29/02

(57) ABSTRACT

An enhanced grip pencil device is provided. In one embodiment, the device is comprised of a pencil body with at least one grip, which is ideally positioned near the tip and made from a deformable material like rubber or foam to enhance comfort during prolonged use. The body of the pencil is preferably triangular, facilitating easier gripping, though it may also be cylindrical. A unique feature of this grip includes at least one recessed area on each side to receive a user's fingers, promoting proper finger placement. Additionally, the invention encompasses methods for using the device, including a specific technique for advancing lead and correctly positioning fingers on the grip. This design significantly surpasses traditional pencils by offering an ergonomic advantage, making it particularly beneficial for those improving their writing skills.

### CROSS-REFERENCE TO RELATED APPLICATION

The present application claims priority to, and the benefit of, U.S. Provisional Application No. 63/493,025, which was filed on Mar. 30, 2023, and is incorporated herein by reference in its entirety.

### FIELD OF THE INVENTION

The present invention relates generally to the field of writing aids. More specifically, the present invention relates to an enhanced grip pencil device that provides a pencil that aids a user in learning to write with proper form. Accordingly, the present disclosure makes specific reference thereto. Nonetheless, it is to be appreciated that aspects of the present invention are also equally applicable to other like applications, devices, and methods of manufacture.

### BACKGROUND

In the early stages of learning, any individual, whether child or adult, often lacks the refined fine motor skills essential for holding and maneuvering a pencil with precision. This deficiency in motor coordination can make it challenging to control the placement and flow of markings on paper. Such challenges can be exceptionally frustrating, particularly for young children who are just embarking on their educational journey. Their small hands are still adapting to various tasks, and writing has become one of the foremost challenges they face.

Similarly, adults who are on the path to recovery from a traumatic injury, neurological condition, or a prolonged illness might find themselves in a comparable situation. They might have once been adept at writing, but due to their circumstances, they may experience a significant loss or reduction in their fine motor abilities. This necessitates a journey of relearning, almost akin to starting from scratch. The process can be disheartening, as they grapple with tasks that were once second nature to them.

For both children and adults in such situations, the mounting frustration can have detrimental effects. It can impede their progress, leading to the development of inadequate writing skills or even the formation of bad habits that can be hard to rectify later on. Moreover, this frustration can sap their confidence, making them more hesitant to practice and improve.

Therefore, there exists a long-felt need in the art for an improved pencil. There also exists a long-felt need in the art for an enhanced grip pencil device. More specifically, there exists a long-felt need in the art for an enhanced grip pencil device that allows the device to be easily gripped. Further, there exists a long-felt need in the art for an enhanced grip pencil device that allows the device to be easily gripped by individuals learning or re-learning how to write using a pencil.

The subject matter disclosed and claimed herein, in one embodiment thereof, comprises an enhanced grip pencil device. In one embodiment, the device is comprised of a pencil body with at least one grip, which is ideally positioned near the tip and made from a deformable material like rubber or foam to enhance comfort during prolonged use. The body of the pencil is preferably triangular, facilitating easier gripping, though it may also be cylindrical. A unique feature of this grip includes at least one recessed area on each side to receive a user's fingers, promoting proper finger placement. Additionally, the invention encompasses methods for using the device, including a specific technique for advancing lead and correctly positioning fingers on the grip. This design significantly surpasses traditional pencils by offering an ergonomic advantage, making it particularly beneficial for those improving their writing skills.

In this manner, the enhanced grip pencil device of the present invention accomplishes all the forgoing objectives and provides an improved pencil. More specifically, the device can be easily gripped due to the unique shape and contour of the grip. As a result, the device can be easily gripped and used by individuals learning or re-learning how to write using a pencil.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an enhanced grip pencil device comprised of a pencil body comprised of at least one grip that facilitates easy gripping and usage of the device. The device preferably has all commonly found features of mechanical pencils, wherein the body is preferably generally triangular in shape with three sides. This aids a user in gripping the body while writing. The body may be other shapes such as cylindrical in different embodiments.

The body is also comprised of at least one grip preferably positioned near the tip of the body. The grip is preferably made from a deformable material such as but not limited to rubber or foam to allow a user to comfortably grab the body for long periods of time.

In one embodiment, the grip is comprised of a three-sided, generally triangular grip wherein each side of the grip is preferably comprised of at least one recessed area that receives one finger of the user to facilitate proper finger placement while using the device to write. In a different embodiment, the device is only comprised of a grip that can be easily applied to any style of pencil to facilitate proper gripping of the pencil. The grip also increases comfort.

The present invention is also comprised of a method of using the device. First, a device is provided comprised of body comprised of a grip. Then a user can press down on an eraser of the device to push lead out of the tip of the body. Next, a user can place a first finger (i.e., the index finger) on a first recessed area of a first side of the grip. Then, a user can place a second finger (i.e., the middle finger) on a second recessed area of a second side of the grip. Next, a user can place a third finger (i.e., a thumb) on a third recessed area of a third side of the grip and use the device to write on paper or another surface or material.

The present invention is also comprised of a second method of using the device. First, a device is provided comprised of a grip comprised of a first side comprised of a first recessed area, a second side comprised of a second recessed area, and a third side comprised of a third recessed area. Then a user can place the grip over the body of an existing pencil. Next, a user can place a first finger (i.e., the index finger) on a first recessed area of a first side of the grip. Then, a user can place a second finger (i.e., the middle finger) on a second recessed area of a second side of the grip. Next, a user can place a third finger (i.e., a thumb) on a third recessed area of a third side of the grip and use the device to write on paper or another surface or material.

Accordingly, the enhanced grip pencil device of the present invention is particularly advantageous as it provides an improved pencil. More specifically, the device can be easily gripped due to the unique shape and contour of the grip. As a result, the device can be easily gripped and used by individuals learning or re-learning how to write using a pencil. In this manner, the enhanced grip pencil device overcomes the limitations of existing pencils known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an enhanced grip pencil device of the present invention in accordance with the disclosed architecture;

FIG. 2 illustrates a perspective view of two potential embodiments of an enhanced grip pencil device of the present invention in accordance with the disclosed architecture;

FIG. 3 illustrates a perspective view of one potential embodiment of an enhanced grip pencil device of the present invention while being gripped by a user in accordance with the disclosed architecture;

FIG. 4 illustrates a flowchart of a method of using one potential embodiment of an enhanced grip pencil device of the present invention in accordance with the disclosed architecture;

FIG. 5 illustrates a flowchart of a method of using one potential embodiment of an enhanced grip pencil device of the present invention in accordance with the disclosed architecture; and

FIG. 6 illustrates a cross-sectional view of a pencil body of one potential embodiment of an enhanced grip pencil device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pencil. There also exists a long-felt need in the art for an enhanced grip pencil device. More specifically, there exists a long-felt need in the art for an enhanced grip pencil device that allows the device to be easily gripped. Further, there exists a long-felt need in the art for an enhanced grip pencil device that allows the device to be easily gripped by individuals learning or re-learning how to write using a pencil.

The present invention, in one exemplary embodiment, is comprised of an enhanced grip pencil device. The device is comprised of a pencil body comprised of at least one grip that facilitates easy gripping and usage of the device. The device preferably has all commonly found features of mechanical pencils, wherein the body is preferably generally triangular in shape with three sides. This aids a user in gripping the body while writing. The body may be other shapes such as cylindrical in different embodiments.

The body is also comprised of at least one grip preferably positioned near the tip of the body. The grip is preferably made from a deformable material such as but not limited to rubber or foam to allow a user to comfortably grab the body for long periods of time.

In one embodiment, the grip is comprised of a three-sided, generally triangular grip. Each side of the grip is preferably comprised of at least one recessed area that receives one finger of the user to facilitate proper finger placement while using the device to write. In a different embodiment, the device is only comprised of a grip that can be easily applied to any style of pencil to facilitate proper gripping of the pencil. The grip also increases comfort.

The present invention is also comprised of a method of using the device. First, a device is provided comprised of body comprised of a grip. Then a user can press down on an eraser of the device to push lead out of the tip of the body. Next, a user can place a first finger (i.e., the index finger) on a first recessed area of a first side of the grip. Then, a user can place a second finger (i.e., the middle finger) on a second recessed area of a second side of the grip. Next, a user can place a third finger (i.e., a thumb) on a third recessed area of a third side of the grip and use the device to write on paper or another surface or material.

The present invention is also comprised of a second method of using the device. First, a device is provided comprised of a grip comprised of a first side comprised of a first recessed area, a second side comprised of a second recessed area, and a third side comprised of a third recessed area. Then a user can place the grip over the body of an existing pencil. Next, a user can place a first finger (i.e., the index finger) on a first recessed area of a first side of the grip. Then, a user can place a second finger (i.e., the middle finger) on a second recessed area of a second side of the grip. Next, a user can place a third finger (i.e., a thumb) on a third recessed area of a third side of the grip and use the device to write on paper or another surface or material.

Accordingly, the enhanced grip pencil device of the present invention is particularly advantageous as it provides an improved pencil. More specifically, the device can be easily gripped due to the unique shape and contour of the grip. As a result, the device can be easily gripped and used by individuals learning or re-learning how to write using a pencil. In this manner, the enhanced grip pencil device overcomes the limitations of existing pencils known in the art.

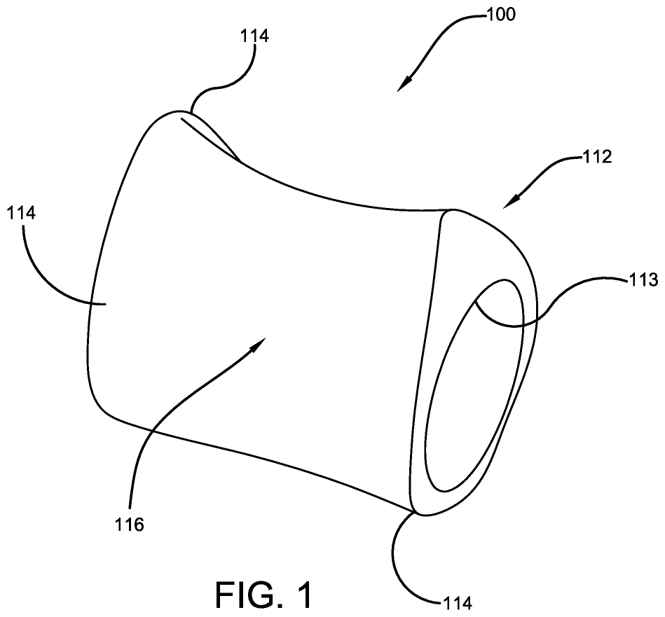

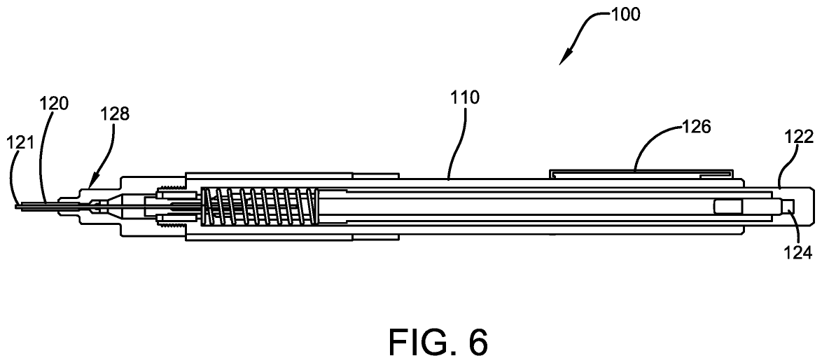

Referring initially to the drawings, FIG. 1 illustrates a perspective view of one potential embodiment of an enhanced grip pencil device 100 of the present invention in accordance with the disclosed architecture. The device 100 is comprised of a pencil body 110 comprised of at least one grip 112 that facilitates easy gripping and usage of the device 100. The device 100 preferably has all commonly found features of mechanical pencils or non-mechanical pencils known in the art, such as but not limited to a lead sleeve 120, a lead advancing mechanism 122, an eraser 124, a clip 126, and a tip 128, in addition to the novel features described below, as seen in FIG. 6.

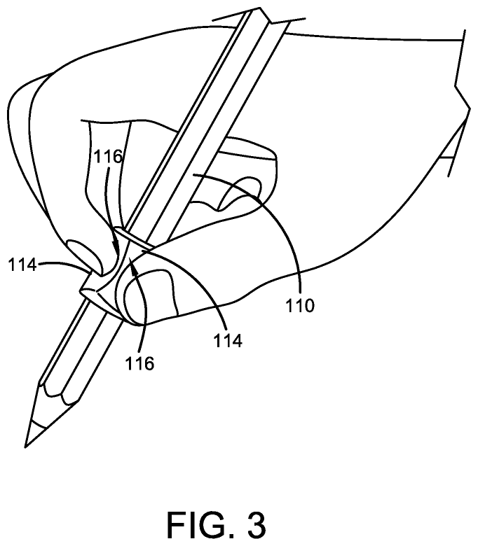

The body 110 is preferably generally triangular in shape with three sides. This aids a user in gripping the body 110 while writing, as seen in FIG. 3. The body 110 may be other shapes such as cylindrical in different embodiments. The body 110 may be made from any material such as plastic, wood, metal, etc.

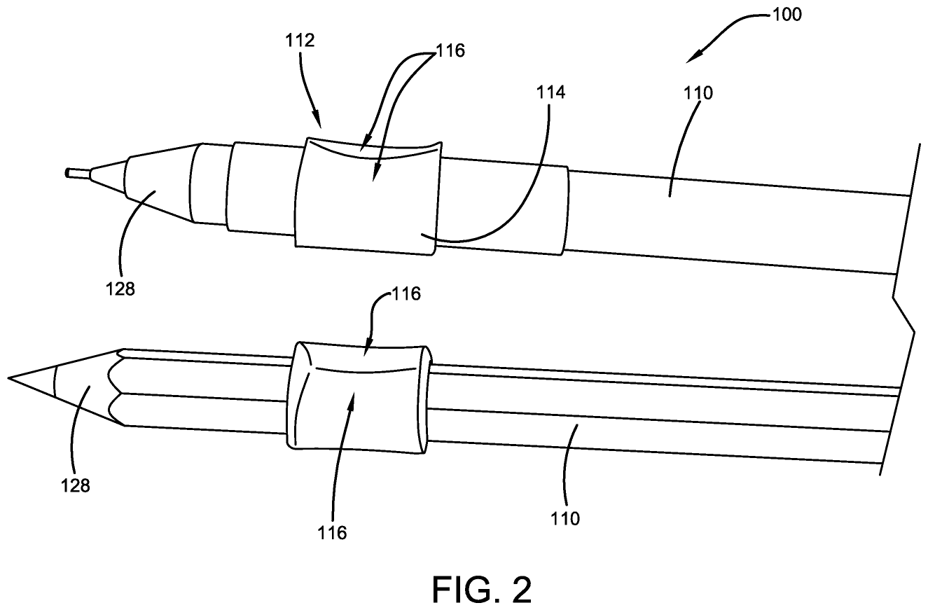

The body 110 is also comprised of at least one grip 112. The grip 112 is preferably positioned near the tip 128 of the body 110 (as seen in FIG. 2) via at least one opening 113 that allows the grip 112 to be placed around/on the body 110. The grip 112 is preferably made from a deformable material such as but not limited to rubber or foam. This allows a user to comfortably grab the body 110 for long periods of time.

In one embodiment, the grip 112 is comprised of a three-sided, generally triangular grip. Each side 114 of the grip 112 is preferably comprised of at least one recessed area 116 that receives one finger of the user to facilitate proper finger placement while using the device 100 to write. In one embodiment, the grip 112 may be comprised of a texture to further increase grip. The texture may be a raised or recessed texture in the form of protrusions, knurling, channels, etc.

In a different embodiment, the device 100 is only comprised of a grip 112, as described above. The grip 112 can be easily applied to any style of pencil to facilitate proper gripping of the pencil. The grip 112 also increases comfort.

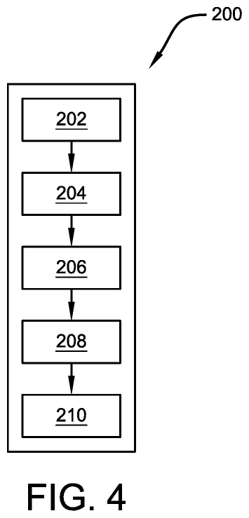

The present invention is also comprised of a method of using 200 the device 100, as seen in FIG. 4. First, a device 100 is provided comprised of a body 110 comprised of a grip 112 [Step 202]. Then a user can press down on an eraser 124 of the device 100 to push lead 121 out of the tip 128 of the body 110 [Step 204]. Next, a user can place a first finger (i.e., the index finger) on a first recessed area 116 of a first side of the grip 112 [Step 206]. Then, a user can place a second finger (i.e., the middle finger) on a second recessed area 116 of a second side of the grip 112 [Step 208]. Next, a user can place a third finger (i.e., a thumb) on a third recessed area 116 of a third side of the grip 112 and use the device 100 to write on paper or another surface or material [Step 210].

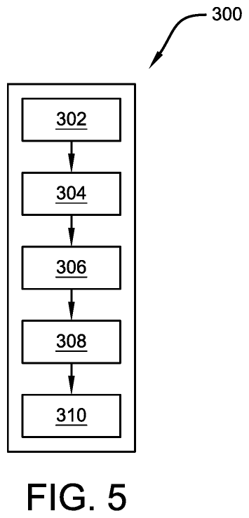

The present invention is also comprised of a second method of using 300 the device 100, as seen in FIG. 5. First, a device 100 is provided comprised of a grip 112 comprised of a first side comprised of a first recessed area, a second side comprised of a second recessed area, and a third side comprised of a third recessed area [Step 302]. Then a user can place the grip 112 over the body of an existing pencil [Step 304]. Next, a user can place a first finger (i.e., the index finger) on a first recessed area 116 of a first side of the grip 112 [Step 306]. Then, a user can place a second finger (i.e., the middle finger) on a second recessed area 116 of a second side of the grip 112 [Step 308]. Next, a user can place a third finger (i.e., a thumb) on a third recessed area 116 of a third side of the grip 112 and use the device 100 to write on paper or another surface or material [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “enhanced grip pencil device” and “device” are interchangeable and refer to the enhanced grip pencil device 100 of the present invention.

Notwithstanding the forgoing, the enhanced grip pencil device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the enhanced grip pencil device 100 as shown in the FIGS. are for illustrative purposes only, and that many other sizes and shapes of the enhanced grip pencil device 100 are well within the scope of the present disclosure. Although the dimensions of the enhanced grip pencil device 100 are important design parameters for user convenience, the enhanced grip pencil device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An enhanced grip pencil device comprising:
a three-sided, triangular body comprised of a grip;
an eraser; and
a lead.

2. The enhanced grip pencil device of claim 1, wherein the grip is comprised of a triangular, three-sided grip.

3. The enhanced grip pencil device of claim 1, wherein the triangular, three-sided grip is comprised of a first side.

4. The enhanced grip pencil device of claim 3, wherein the first side is comprised of a first recessed area.

5. The enhanced grip pencil device of claim 1, wherein the triangular, three-sided grip is comprised of a second side.

6. The enhanced grip pencil device of claim 5, wherein the second side is comprised of a second recessed area.

7. The enhanced grip pencil device of claim 5, wherein the triangular, three-sided grip is comprised of a third side.

8. The enhanced grip pencil device of claim 1, wherein the third side is comprised of a third recessed area.

9. An enhanced grip pencil device comprising:
a three-sided, triangular body comprised of a three-sided, triangular grip comprised of a first side, a second side, and a third side;
an eraser;
a clip;
a lead; and
a lead advancing mechanism.

10. The enhanced grip pencil device of claim 9, wherein the first side is comprised of a first recessed area.

11. The enhanced grip pencil device of claim 9, wherein the second side is comprised of a second recessed area.

12. The enhanced grip pencil device of claim 9, wherein the third side is comprised of a third recessed area.

13. The enhanced grip pencil device of claim 9, wherein the grip is comprised of a deformable material.

14. The enhanced grip pencil device of claim 13, wherein the deformable material is comprised of a rubber or a foam material.

15. The enhanced grip pencil device of claim 9, wherein the grip is comprised of a texture.

16. The enhanced grip pencil device of claim 15, wherein the texture is comprised of a raised texture.

17. The enhanced grip pencil device of claim 15, wherein the grip is comprised of a recessed texture.

18. A method of using an enhanced grip pencil device, the method comprising the following steps:
providing an enhanced grip pencil device comprised of a three-sided, triangular body comprised of a three-sided, triangular grip;
placing a first finger on a first recessed area of a first side of the three-sided, triangular grip;
placing a second finger on a second recessed area of a second side of the three-sided, triangular grip;
placing a third finger on a third recessed area of a third side of the three-sided, triangular grip; and
using the enhanced grip pencil device to write.

19. The method of using an enhanced grip pencil device of claim 18 further comprised of a step of pressing down on an eraser of the enhanced grip pencil device.

20. The method of using an enhanced grip pencil device of claim 18, wherein the three-sided, triangular grip is comprised of a deformable material.
